(19) United States
(12) Patent Application Publication
(10) Pub. No.: US 2003/0115334 A1
(43) Pub. Date: Jun. 19, 2003

(54) Business transaction monitoring system and method

(76) Inventors: Sunil Bhat, Colorado Springs, CO (US); Michael O. Watry, Colorado Spring, CO (US); Bruce Kosbab, Colorado Springs, CO (US)

Correspondence Address: Law Office of Dale B. Halling, LLC, Suite 311, 24 South Weber Street, Colorado Springs, CO, 80903, US

(21) Appl. No.: 10/287,439

(22) Filed: Nov. 4, 2002

Related U.S. Application Data
(60) Provisional application No. 60/332,589, filed on Nov. 5, 2001.

(51) Int. Cl. G06F 15/16; G06F 17/60

(52) U.S. Cl. 709/227; 705/1

(57) ABSTRACT

A business transaction monitoring system has a agent monitoring a first low level protocol. A collector receives a low level protocol information from the data agent. A business transaction monitor server is coupled to the network and receives a plurality of business function transaction information from the collector.

### RELATED APPLICATIONS

The present invention claims priority on provisional patent application Serial No. 60/332,589, filed on Nov. 5, 2001, entitled “Real-Time Monitoring of Business transactions Using Non-Intrusive Means”.

### FIELD OF THE INVENTION

The present invention relates generally to the field of computer networks and more particularly to a business transaction monitoring system and method.

### BACKGROUND OF THE INVENTION

The Internet has become a very popular tool to conduct business transactions. The Internet allows customers instant access to business transactions and reduces the cost of delivering these transaction or services. For instance, some banks provide the ability for customers to apply for lines of credit on the Internet. Despite these advantages, if a customer has a problem completing the business transaction online the business offering the service may never hear from the customer. The reasons the customer may not complete the transaction may include network problems, software application problems or customer frustration with the process. Since the process is online, the company may never know of the problem. There are a number of products that monitor network problems. These products do not let the company know when there are software application problems or when the customer has become frustrated with the process. A few products monitor for software application problems. However none of the products have a business activity monitoring capability.

Thus there exists a need for a business transaction monitoring system and method that has a business activity monitoring capability for monitoring online products and services.

### SUMMARY OF INVENTION

A business transaction monitoring system has a business transaction monitoring sever coupled to a network. A collector is coupled to the network. The collector collects a business function information and transmits it to the business transaction monitoring sever. In one embodiment, the collector receives a low level protocol information from a data agent. In another embodiment, the collector has a business function monitor that converts the low level protocol information into a business function transaction information. In another embodiment, the collector transmits the business function transaction information to the business transaction monitoring sever. In one embodiment, the collector has a user monitoring component.

In another embodiment, the business transaction monitoring sever has a data aggregation component and a time correlation component. In one embodiment, the system includes a plurality of data agents each monitoring a low level protocol stream and passing low level protocol information to the pair of collectors. In one embodiment, a method of monitoring business transactions includes the steps of monitoring a low level protocol stream on a network by a data agent. Next, it is determined if the low level protocol stream contains a business function transaction. When the low level protocol stream contains the business function transaction, a business function transaction information is transmitted to a business transaction monitoring sever.

In one embodiment, it is determined if the low level protocol stream contains a user session. When the low level protocol stream contains the user session, a user session information is transmitted to the business transaction monitoring server. In one embodiment, a begin module of the business transaction function is defined. In another embodiment, a token associated with the begin module is defined. In another embodiment, a protocol associated with the begin module is defined.

In one embodiment, the business function transaction information is aggregated.

In one embodiment, a business transaction monitoring system includes a first data collection agent that monitors a first low level protocol stream at a first point of a network. A second data collection agent monitors a second low level protocol stream at a second point of the network. A business transaction monitor server is coupled to the network and receives a plurality of business function transaction information from the first data collection agent and the second data collection agent. In one embodiment, the first data collection agent includes a data interface component and a data analysis component. In another embodiment, the data analysis component has a business function transaction monitor component and a user monitor component. In another embodiment, the business function transaction monitor component has a begin module and an end module. In one embodiment, the end module has a token and a protocol definition.

In one embodiment, the business transaction monitor server has a data aggregation component and a time correlation component. In another embodiment, the time correlation component tracks a time to complete a group of business function transactions.

### BRIEF DESCRIPTION OF THE DRAWINGS

FIG. 1 is a block diagram of a system for providing online business transactions that includes a business transaction monitoring system in accordance with one embodiment of the invention;

FIG. 2 is a block diagram of a business transaction monitoring server in accordance with one embodiment of the invention;

FIG. 3 is a block diagram of a collector in accordance with one embodiment of the invention; and

FIG. 4 is a flow chart of the steps used in a method of a business transaction monitoring in accordance with one embodiment of the invention.

### DETAILED DESCRIPTION OF THE DRAWINGS

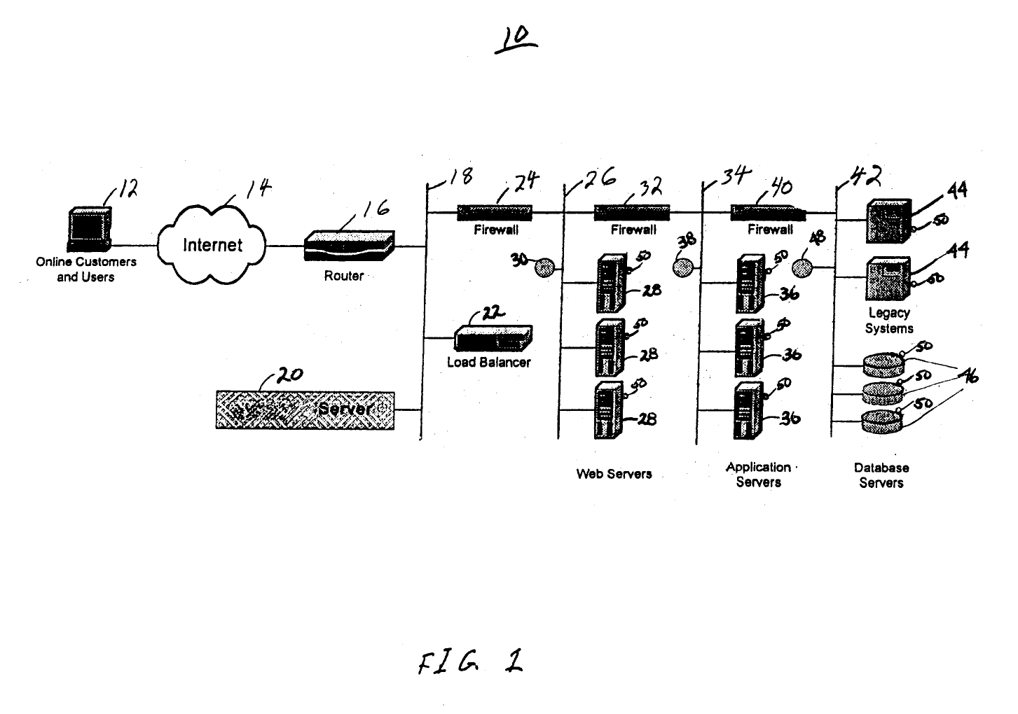

FIG. 1 is a block diagram of a system 10 for providing online business transactions that includes a business transaction monitoring system in accordance with one embodiment of the invention. The business transaction monitoring system is used to monitor online services, products and business transactions. An online customer 12 connects through the Internet 14 or intranet to a router 16 at a business. The router 16 is coupled to a first local area network (LAN) 18 that is coupled to a business transaction monitoring server 20, a load balancer 22 and a first firewall 24. The first firewall 24 is connected to a second LAN 26. The second LAN 26 is connected to a plurality of web servers 28. The second LAN 26 is also connected to a collector 30. The collector 30 is a software agent that can reside on a separate computer or can reside on any of the web servers 28. A second firewall 32 connects the second LAN 26 to a third LAN 34. The third LAN 34 is connected to a plurality of application servers 36. The third LAN 34 is also connected to a second collector 38. A third firewall 40 connects the third LAN 34 to a fourth LAN 42. The fourth LAN 42 is connected to a plurality of legacy systems 44, a plurality of database servers 46 and a third collector 48. A plurality of data agents 50 reside on the various network components. The data agents monitor low level traffic and pass relevant information on to the collectors 30, 38, 48. Note that the network shown in figure one is representative of one possible configuration, other configurations will be apparent to those skilled in the art. The business transaction monitoring system includes the business transaction monitoring server 20, the three collectors 30, 38 & 48 and a plurality of data agents 50. The data agents 50 are real-time software that interfaces with the data stream and detects and measures business function transactions non-intrusively. Non-intrusive is defined as not requiring any modifications to an application that is being monitored. There are four general types of data agents 50: network agents; network agents, web server plug-ins; application server plug-ins; and custom agents. The network agents monitor packets off the network line. The web server plug-ins monitor logical packets from appropriate software APIs (Application Program Interface). The application server plug-ins monitor logical packets from appropriate application sever software API. Custom agents are custom to the application component and use any API's supported by the application component. Multiple agents 50 monitor low-level data stream(s) at one or more locations and pass low-level information to a collector 30, 38, 48. One or more collectors 30, 38, 48 correlates these low-level data streams into a merged data stream and determines if the merged low level data stream contains a high-level business function transaction(s). The business function transaction information is transmitted to the server for aggregation. The software plug-ins may reside on the production servers (Web server/App. server) themselves. The network agent/collector combination may run on a dedicated PC (known in the industry as a ‘network probe’).

The business transaction monitoring server 20 aggregates business function information from the distributed collectors 30, 38 & 48. The business transaction monitoring server 20 may be located anywhere, on-site or outside at a remote location. There is no requirement that the monitoring server 20 be within the firewall. In addition the server 20 correlates and analyzes the aggregated data. A typical installation has multiple data agents 50 commonly residing on the network component. A group of data agents 50 will report relevant low level traffic information to a collector 30. The collector time correlates low-level traffic data from one or more data agents and infers business function transactions from the merged data stream. The collectors may be placed where they can monitor the network traffic between site components. The network architecture of the site will dictate where collectors and agent will be placed. Some networks use switches to maximize the performance of the network. A network data agent may be deployed on a machine that is connected to a port on the switch. By configuring this port to mirror another or span the other ports, the data agent can monitor network packets on the network segment.

A business function transaction is defined herein as a logical set of interactions between users and an application or between various components within an application or between applications. Some examples include ‘browse catalog’, ‘login’, ‘course registration’, ‘submit order’, ‘add to cart’ and ‘transfer funds’. These are all business functions that have either content or transactions associated with them. There are three basic categories of business function transactions. User-facing business functions in which users interact with an application by invoking actions on a web site, via email or other. This category of business functions includes user interactions with the application. A second category is intra-application business functions. This category consists of transactions that occur among components within an application. An enterprise class application typically consists of several components each of which may exchange data in a number of different methods. The third category is inter-application business functions. This category include communication that occurs between applications.

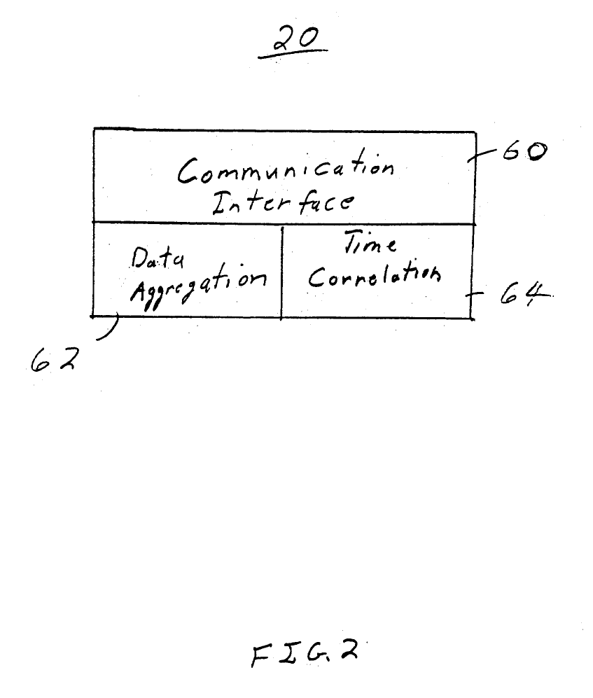

FIG. 2 is a block diagram of a business transaction monitoring server 20 in accordance with one embodiment of the invention. The server 20 has a communication interface 60 that allows the server 20 to communicate over the network. The server 20 also has a data aggregation component 62 and a time correlation component 64. The data aggregation component 62 aggregates data or business function information from the plurality of collectors 30, 38 & 48. The collectors 30, 38 & 48 only monitor a subset of the business transactions. The data aggregation component 62 merges and aggregates the information from the individual collectors 30, 38 & 48. Note that a transaction between a user 12 (FIG. 1) and a web server 28 typically results in one or more application transactions between the web server and one or more application servers or database servers. The server has the ability to map (or match) the source transaction to its resultant transactions. The implementation of the mapping process varies with the type of systems involved. One example is mapping high level business transactions over multiple low level protocol transactions. This is done by using start and end tokens that allow the system to determine a high level business transaction from a stream of low-level underlying transactions. If only a start token is specified, the system determines the business request based on the start token and assumes the response to the request to be the end of the business transaction. Another example of mapping involves mapping an end-user business function transaction at a give tier to it resultant back-end transactions at the next tier. This requires custom correlators that uniquely tie an identifier of the source transaction to identifiers in the resultant transcations within the next tier of the application infrstructure.

The time correlation component 64 determines the time between various business function transactions that make up part of a business transaction. Generally time correlation is a process of correlating business function transactions for a given time period with that of the resultant back-end transactions for the same time period. For example, if the system saw 5 business function transactions over a period of 10 minutes and the system monitors 15 back-end transactions over the same time, then these 15 backend transactions belong (based on time of occurrence) to the 5 business function transactions. However, to be able to pick the exact back-end transactions that apply to a specific business function transaction requires additional semantic correlation, which is tied to the behavior of the specific application. When a problem is detected, the time correlation component 64 allows the company to identify problem areas.

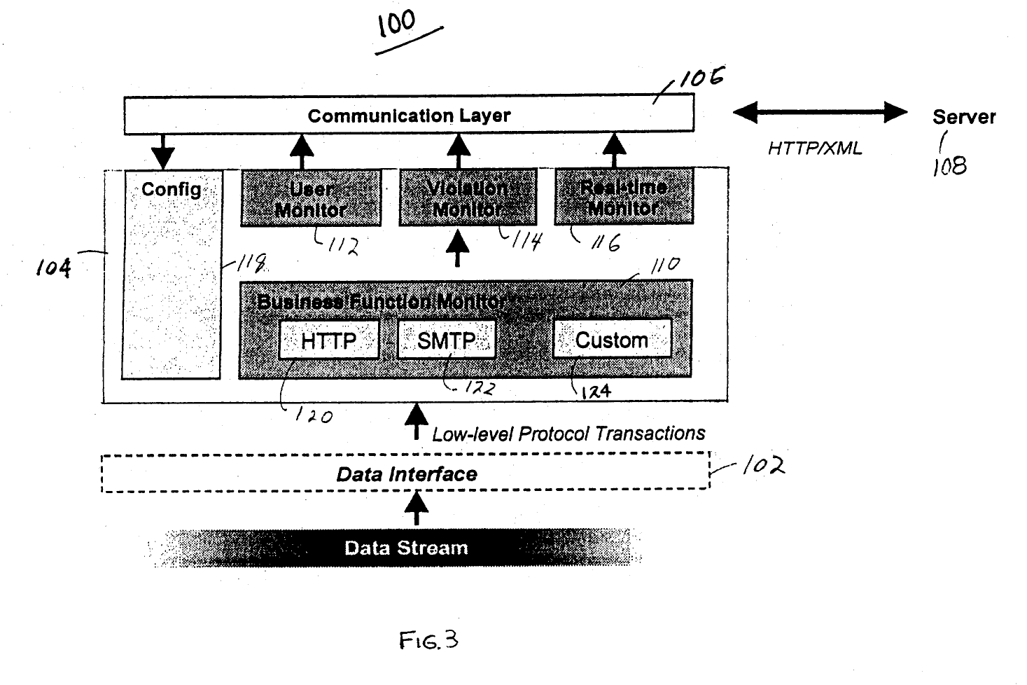

FIG. 3 is a block diagram of a collector 100 in accordance with one embodiment of the invention. The collector 100 has a data interface component 102 that receives the low level protocol transactions from the agents and passes them on to a data analysis component 104. The data analysis component 104 filters the low level protocol transactions to collect business function information. The business function information is passed on to the communication layer 106 for transmission to the business transaction monitoring server 108. In one embodiment, the communication protocol between the collector 100 and the server 108 is HTTP (HyperText Transfer Protocol) and XML (eXtensible Markup Language).

The data interface component 102 may be connected to a passive network monitoring agent, a web server plug-in agent, an application server plug-in or a custom agent. The custom agent is used in proprietary environments.

The data analysis component 104 includes a business function transaction monitoring component 110, a user monitoring component 112, a violations monitoring component 114 and a real-time monitoring component 116. In addition the data analysis component 104 includes a configuration component 118.

The business function monitor 110 acts as a filter that takes the received stream of low-level protocol transactions from the agents and passes on only the high-level business function transactions. It also creates a log of the transactions, which is uploaded to the server. The business function monitor 110 has a number of individual protocol specific modules 120, 122, 124 that handle both the syntax and the semantics of transactions for the specific protocol. In one embodiment, a business function is defined by a begin module and an end module. The begin or end module includes a protocol, a token and required parameters. The protocol defines the protocol associated with the business function. The token may be a pattern of textual data or a field of a specific length at a particular offset in the case of binary data.

The user monitor 112 tracks individual user sessions from login to logout. This allows the system to identify the user associated with every business function transaction.

The violations monitor 114 detects a wide range of exception conditions or violations. For example the monitor detects protocol errors, performance service level agreement violations, customer user defined application errors and other errors. The exceptions are detected in real-time and are sent to the server along with context information such as the user.

The real-time monitor 116 measures transaction response time and other key metrics. It also keeps counters on performance, errors, users, etc. that provide information for the time correlation component 64 of the server 20.

The configuration component 104 contains the business functions, rules and events that determine what data the collector gathers and how the collector should interpret the data.

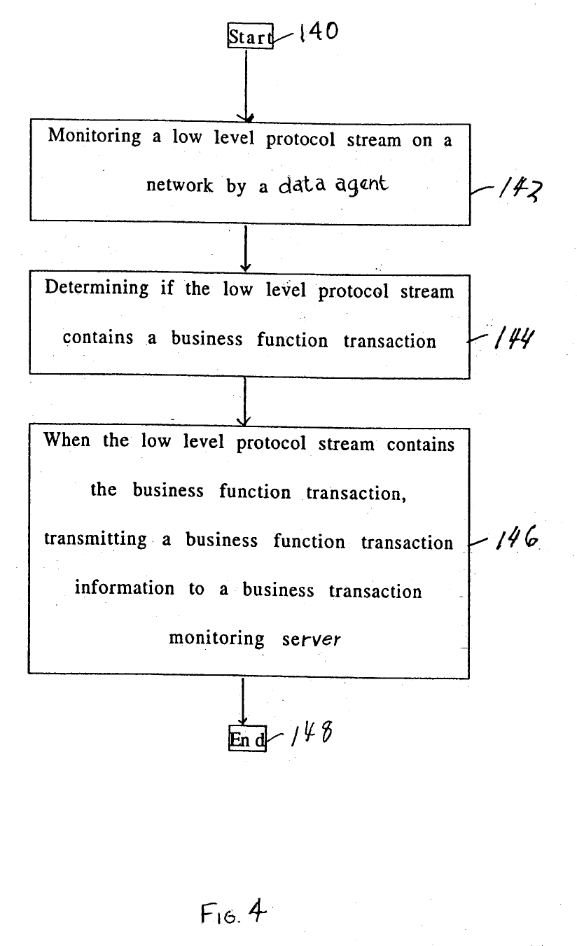

FIG. 4 is a flow chart of the steps used in a method of a business transaction monitoring in accordance with one embodiment of the invention. The process starts, step 140, by monitoring a low level protocol stream on a network by a data agent at step 142. Next it is determined if the low level protocol stream contains a business function transaction at step 144. At step 146 when the low level protocol stream contains a business function transaction, a business function transaction information is transmitted to a business transaction monitoring server which ends the process at step 148. In one embodiment, the business function transaction information is aggregated to form a business transaction information. In one embodiment, the collector determines if the low level protocol stream contains a user session. When the low level protocol stream contains a user session, the user session information is transmitted to the business transaction monitoring server.

In one embodiment, a begin module is defined for the business function transaction. The begin module may contain a token and a protocol associated with the business function transaction.

Thus there has been described a business transaction monitoring system and method that has a business activity monitoring capability for monitoring online services and products. This is an invaluable tool to online business providers to deliver top quality service.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A business transaction monitoring system, comprising:
a business transaction monitoring sever coupled to a network; and
a collector coupled to the network, collecting a business function information and transmitting it to the business transaction monitoring sever.

2. The business transaction monitoring system of claim 1, wherein the collector receives a low level protocol information from a data agent.

3. The business transaction monitoring system of claim 2, wherein the collector has a business function monitor that converts the low level protocol information into a business function transaction information.

4. The business transaction monitoring system of claim 3, wherein the collector transmits the business function transaction information to the business transaction monitoring sever.

5. The business transaction monitoring system of claim 1, wherein the collector has a user monitoring component.

6. The business transaction monitoring system of claim 1, wherein the business transaction monitoring sever has a data aggregation component and a time correlation component.

7. The business transaction monitoring system of claim 1, further including a plurality of data agents each monitoring a low level protocol stream and passing low level protocol information to the pair of collectors.

8. A method of monitoring business transactions, comprising the steps of:
a) monitoring a low level protocol stream on a network by a data agent;
b) determining if the low level protocol stream contains a business function transaction; and
c) when the low level protocol stream contains the business function transaction, transmitting a business function transaction information to a business transaction monitoring sever.

9. The method of monitoring business transactions of claim 8, wherein step (b) further includes the steps of:
b1) determining if the low level protocol stream contains a user session;
b2) when the low level protocol stream contains the user session, transmitting a user session information to the business transaction monitoring server.

10. The method of monitoring business transactions of claim 8, wherein step (b) further includes the step of:
b1) defining a begin module of the business transaction function.

11. The method of monitoring business transactions of claim 10, further including the step of defining a token associated with the begin module.

12. The method of monitoring business transactions of claim 10, further including the step of defining a protocol associated with the begin module.

13. The method of monitoring business transactions of claim 8, further including the step of:
d) aggregating the business function transaction information.

14. A business transaction monitoring system, comprising:
a agent monitoring a first low level protocol;
a collector receives a low level protocol information from the data agent; and
a business transaction monitor server coupled to the network and receiving a plurality of business function transaction information from the collector.

15. The business transaction monitoring system of claim 14, wherein the collector includes a data interface component and a data analysis component.

16. The business transaction monitoring system of claim 15, wherein the data analysis component has a business function transaction monitor component and a user monitor component.

17. The business transaction monitoring system of claim 16, wherein the business function transaction monitor component has a begin module and an end module.

18. The business transaction monitoring system of claim 17, wherein the end module has a token and a protocol definition.

19. The business transaction monitoring system of claim 14, wherein the business transaction monitor server has a data aggregation component and a time correlation component.

20. The business transaction monitoring system of claim 19, wherein the time correlation component tracks a time to complete a group of business function transactions.
